(19) United States
(12) Patent Application Publication
(10) Pub. No.: US 2026/0212558 A1
(43) Pub. Date: Jul. 23, 2026

(54) CRAFTING LAYERED DIGITAL DESIGN DOCUMENTS FROM RASTERIZED IMAGES

(71) Applicant: Adobe Inc., San Jose, CA (US)

(72) Inventors: Jingye Chen, Hong Kong (HK); Zhaowen Wang, San Jose, CA (US); Nanxuan Zhao, San Jose, CA (US); Li Zhang, Sunnyvale, CA (US); Difan Liu, San Jose, CA (US); Jimei Yang, Merced, CA (US)

(21) Appl. No.: 19/035,540

(22) Filed: Jan. 23, 2025

(51) Int. Cl. G06T 11/60; G06T 7/11; G06T 7/194; G06V 30/10

(52) U.S. Cl. CPC G06T 11/60; G06T 7/11; G06T 7/194; G06V 30/10; G06T 2200/24

(57) ABSTRACT

The present disclosure relates to systems, methods, and non-transitory computer-readable media that generates a layered digital design document from a reference image. In particular, the disclosed systems generate a design plan architecture by extracting design elements from a reference image. Furthermore, the disclosed systems generate a layered digital design document from the reference image by extracting the design elements from the reference image according to the design plan architecture and further constructing the layered digital design document from the extracted design elements. Moreover, the disclosed systems provide, to a graphical user interface of a client device, the layered digital design document.

### BACKGROUND

Recent years have seen significant advancements in hardware and software platforms for creating and modifying digital design documents. For example, many platforms offer software applications that provide tools to modify objects within digital design documents. For instance, many platforms provide templates to select from to use as a digital design document. Despite advancements in creating and modifying digital design documents, conventional platforms suffer from a variety of issues in relation to efficiency, accuracy, and operational flexibility of creating and modifying digital design documents.

### SUMMARY

One or more embodiments described herein provide benefits and/or solve one or more of the problems in the art with systems, methods, and non-transitory computer-readable media that generate a layered digital design document from a reference image (e.g., a raster image) utilizing a multi-modal language model (e.g., a vision language model). For example, in one or more embodiments, the disclosed systems generate a design plan architecture by extracting design elements from the reference image. Further, in one or more embodiments, the disclosed systems generate a layered digital design document from the reference image by extracting the design elements from the reference image according to the design plan architecture. The discloses system construct the layered digital design document from the extracted design elements. Moreover, in one or more embodiments, the disclosed systems provide the layered digital design document to a graphical user interface of a client device.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which a layered digital design system operates in accordance with one or more implementations;

FIG. 2 illustrates an overview diagram of the layered digital system generating a layered digital design document from a non-layered rasterized image in accordance with one or more implementations;

FIG. 3 illustrates a diagram of the layered digital design system using a graphic design generation framework to create a layered digital design document in accordance with one or more implementations;

FIG. 4A illustrates an example diagram of the layered digital design system generating a reference image in accordance with one or more implementations;

FIG. 4B illustrates an example diagram of the layered digital design system using in-context learning to generate a prompt from a user intention in accordance with one or more implementations;

FIG. 4C illustrates an example diagram of the layered digital design system using a digital sketch to generate a prompt to further generate a reference image in accordance with one or more implementations;

FIG. 5 illustrates an example diagram of the layered digital design system generating a design plan architecture from a reference image and additional details of generating a combined prompt in accordance with one or more implementations;

FIGS. 6A-6B illustrates an example diagram of the layered digital design system iteratively removing design elements from a reference image to generate multiple layers from a reference image in accordance with one or more implementations;

FIG. 7 illustrates an example diagram of the layered digital design system generating a plurality of results at each iterative stage of removing a design element and using the multi-modal language model to sample one of the results in accordance with one or more implementations;

FIG. 8 illustrates a schematic diagram of the layered digital design system in accordance with one or more implementations;

FIG. 9 illustrates a flowchart of a series of acts for generating a layered digital design document from a reference image in accordance with one or more implementations;

FIG. 10 illustrates a block diagram of an exemplary computing device in accordance with one or more implementations.

### DETAILED DESCRIPTION

One or more embodiments described herein include a computationally accurate, efficient, and operationally flexible system capable of leveraging non-layered images and using a graphic design generation framework to create a layered digital design document from the non-layered image. Specifically, with the advancement of generative models, high-quality graphic designs created in a raster format (e.g., pixel format) make a wide variety of templates and designs readily available to designer client devices. As described in greater detail below, a layered digital design system utilizes three stages of a graphic design generation framework centered around a multi-modal language model (e.g., a vision language model) to transform graphic designs in a raster format (e.g., generated as part of an AI pipeline) to a layered digital design document. For example, the three stages of the graphic design generation framework include reference creation, design planning, and layer generation. Specifically, the layered digital design system uses a reference image as a global design guidance to ensure that elements within the digital design document are visually harmonious (e.g., as many AI-generated images contain unharmonious elements). Furthermore, the layered digital design system generates a design plan architecture from the reference image and further uses the design plan architecture to facilitate the creation of editable graphic layers (e.g., in a layered digital design document).

As mentioned above, the layered digital design system uses a graphic design generation framework that includes a first stage for reference creation. In some embodiments, the layered digital design system receives a reference image from a client device and uses the reference image to generate the design plan architecture. In some embodiments, the layered digital design system receives a user intention and/or a digital sketch from a client device and uses a generative model to generate the reference image. In other words, the layered digital design system uses either generative methods to arrive at the reference image or receives the reference image directly from the client device. Specifically, in some instances, the layered digital design system receives a user intention and generates a prompt to expand on the user intention. Moreover, the layered digital design system uses the prompt to create the reference image as a global reference for further creating a design plan architecture.

As part of the second stage for design planning, the layered digital design system derives a design plan architecture from the reference image (e.g., a rasterized reference image). Specifically, the layered digital design system creates a design plan architecture that details the placement of objects within the reference image to subsequently extract design elements from the reference image. Furthermore, the layered digital design system further generates the design plan architecture that includes rendering attributes of text to facilitate the construction of text layers. In some embodiments, the layered digital design system processes the reference image alongside a prompt (e.g., the prompt includes descriptive information to help the layered digital design system refine any nonsensical text in the reference image) to generate the design plan architecture. For instance, the design plan architecture contains JSON objects representing attributes of elements in the reference image arranged in a bottom-top order.

Furthermore, as part of the third stage for layer generation, the layered digital design system constructs the layered digital design document based on the design plan architecture generated from the second stage and the reference image generated from the first stage. Specifically, the layered digital design system iteratively removes elements from the reference image according to the design plan architecture and stacks them back together to construct the final layered digital design document.

As mentioned above, conventional systems suffer from a number of issues relating to computational inaccuracies, computational inefficiencies, and operational inflexibilities. For example, conventional systems suffer from computational inaccuracies due to the complexity of creating layered graphic designs. Specifically, conventional systems attempt to leverage generative models to create layered graphic designs, however these models typically generate visual conflicts (e.g., conventional systems fail to allocate sufficient or suitable space for text or objects when generating a background), which often results from a lack of a global visual impression. Furthermore, existing models typically fail to adequately detect and identify more complex elements in complex digital design documents. Further, existing models also tend to fail to identify a level of detail sufficient to generate accurate design documents.

In addition, conventional systems further suffer from inaccuracies due to the lack of example diversity in existing models. Specifically, conventional systems are typically constrained to generating content related to natural images, and thus, often fail to adapt to additional domains. For instance, conventional systems fail to accurately generate digital design documents that contain human objects, car objects, and other non-natural domains. Moreover, non-natural domains in combination with text objects further exacerbate accuracy concerns as existing models are not typically fully optimized to work in these contexts.

Furthermore, conventional systems suffer from computational inefficiencies due to the prompting and re-prompting that occurs in existing models. Specifically, related to the accuracy concerns, conventional systems typically incorrectly generate digital design documents (e.g., create visual conflicts or content that is not correctly depicted due to the lack of example diversity), which results in client devices prompting and re-prompting existing models to regenerate content.

Moreover, conventional systems further suffer from computational inefficiencies due to client devices attempting to create various design templates to satisfy their design requirements. Specifically, as mentioned above, conventional systems have a limited number and variety of design templates available for designers, thus, designers of client device are sometimes required to create design templates from scratch that better match their design use cases. As such, conventional systems consume resources and time in attempting to generate digital design documents.

Related to the accuracy and efficiency concerns, conventional systems further suffer from operational inflexibilities. Specifically, conventional systems are limited in the type of digital design document templates that are readily available. Furthermore, conventional systems are typically not adept at generating robust and accurate design documents that are editable and practical for a user to use for their design use cases. As such, conventional systems are operationally rigid in providing diverse and high-quality digital design documents for a designer.

In one or more embodiments, the layered digital design system improves upon computational inaccuracies, computational inefficiencies, and operational inflexibilities. In contrast to conventional systems, which attempt to generate digital design templates from scratch using generative models (e.g., and which are riddled with visual conflicts), the layered digital design system directly transforms a reference image in rasterized form into a layered digital design document (e.g., editable design document). Specifically, the layered digital design system is not bogged down from lacking a global visual impression of a design document but rather uses a reference image that already possess sufficient/suitable space for text and/or objects.

For instance, the layered digital design system leverages reference images received directly from a client device or uses generative AI models to generate the reference image. Even though the reference image is in a rasterized format, the layered digital design document accurately improves upon computational inaccuracies and transforms the rasterized version of the image into a layered digital design document based on a design plan architecture. Specifically, the layered digital design system extracts the design elements and then constructs the design document from the extracted elements from the reference image according to the design plan architecture.

Moreover, in one or more embodiments, the layered digital design system further improves upon inaccuracies of conventional systems by using a multi-modal language model, which is specially trained to generate the design plan architecture. In contrast to conventional systems, which are typically constrained to the natural image domain, the layered digital design system optimizes a multi-modal language model by training it on a variety of digital design templates (e.g., that each contain metadata for multiple types of layers, objects, and various elements). In doing so, the layered digital design system exposes the multi-modal language model to a wide variety of examples and improves its ability to generate accurate digital design documents. In other words, the layered digital design document accurately generates a layered digital design document due to generating a high-quality design plan architecture that captures the bottom-top order of a reference image.

Furthermore, the layered digital design system uses a multi-modal language model to generate tokens compatible for both the image and text domains. As such, the layered digital design system uses a model that captures both the reference image and the prompt (e.g., the includes an accurate description of what is to be generated) and generates the design plan architecture from both of those inputs. In doing so, the layered digital design system more accurately generates layered digital design documents in a high-quality manner.

Additionally, in one or more embodiments, the layered digital design system improves upon computational inefficiencies. In contrast to conventional systems which incorrectly generate digital design documents, the layered digital design system more accurately generates layered digital design documents on a first-pass. Thus, avoiding the prompting and re-prompting of generative models.

Moreover, the layered digital design system further improves upon efficiency by reducing the need to generate custom design templates. For example, due to the improvements in generative AI models, many designers leverage generative AI models to generate high-quality design images that satisfy their design use cases. Even though these AI generated images are in a rasterized format, in one or more embodiments, designers utilize the layered digital design system to transform a high-quality AI generated images into layered digital design documents. In doing so, the layered digital design system saves computational resources and time (e.g., system-wide the layered digital design system reduces the need for creating and re-creating templates from scratch).

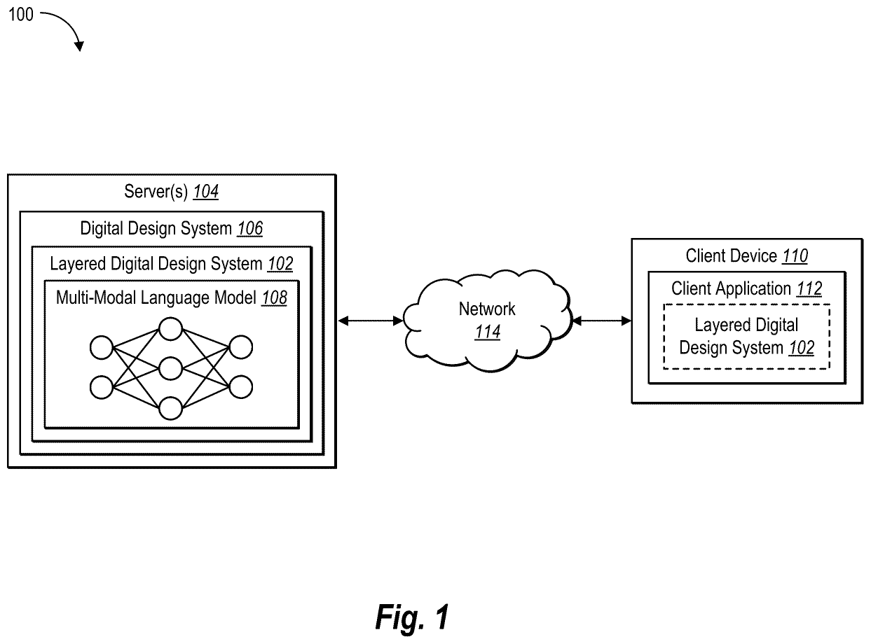

Additional details regarding the layered digital design system will now be provided with reference to the figures. For example, FIG. 1 illustrates a schematic diagram of an exemplary system environment 100 in which a layered digital design system 102 operates. As illustrated in FIG. 1, the system environment 100 includes server(s) 104, a digital design system 106, a network 114, and a client device 110. Additionally, FIG. 1 illustrates that the digital design system 106 includes the layered digital design system 102, which further includes a multimodal large language model 108. Moreover, the client device 110 includes a client application 112.

Although the system environment 100 of FIG. 1 is depicted as having a particular number of components, the system environment 100 is capable of having a different number of additional or alternative components (e.g., a different number of servers, client devices, or other components in communication with the layered digital design system 102 via the network 114). Similarly, although FIG. 1 illustrates a particular arrangement of the server(s) 104, the network 114, and the client device 110, various additional arrangements are possible.

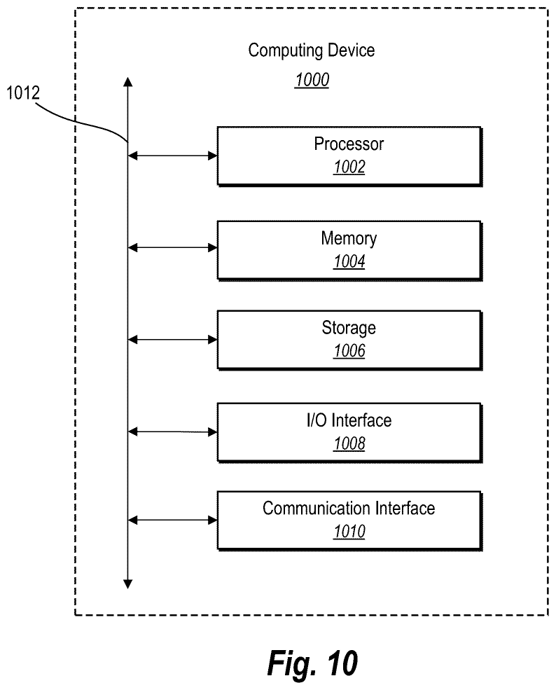

The server(s) 104, the network 114, and the client device 110 are communicatively coupled with each other either directly or indirectly (e.g., through the network 114 discussed in greater detail below in relation to FIG. 10). Moreover, the server(s) 104 and the client device 110 include one or more of a variety of computing devices (including one or more computing devices as discussed in greater detail in relation to FIG. 10).

As mentioned above, the system environment 100 includes the server(s) 104. In one or more embodiments, the server(s) 104 process input for generating a layered digital design document. In one or more embodiments, the server(s) 104 comprise a data server. In some implementations, the server(s) 104 comprise a communication server or a web-hosting server.

In one or more embodiments, the client device 110 includes computing devices associated with the one or more user accounts that access digital design documents, digital images, and further submit user intentions for the layered digital design system 102 to generate reference image and a layered digital design document. In one or more embodiments, the layered digital design system 102 utilizes the multimodal large language model 108 to generate a reference image, a prompt, a design plan architecture, and a layered digital design document.

In one or more embodiments, the client device 110 includes smartphones, tablets, desktop computers, laptop computers, head-mounted-display devices, or other electronic devices. The client device 110 includes one or more software applications (e.g., the client application 112 includes a digital design editing application) for submitting a user intention to generate a layered digital design documents that includes text and image elements. In one or more embodiments, the client application 112 includes a software application hosted on the server(s) 104 accessible by the client device 110 through another application, such as a web browser.

To provide an example implementation, in one or more embodiments, layered digital design system 102 on the server(s) 104 supports the layered digital design system 102 on the client device 110. For instance, in some cases, the digital design system 106 on the server(s) 104 trains one or more components of the layered digital design system 102 (e.g., trains the multimodal large language model 108). In one or more embodiments, the client device 110 obtains (e.g., downloads) the layered digital design system 102 trained on the server(s) 104 for implementation. Once downloaded, the layered digital design system 102 (e.g., which was trained on the server(s) 104) on the client device 110 is able to operate independent from the server(s) 104 to generated layered digital designs from raster images.

In alternative implementations, the layered digital design system 102 includes a web hosting application that allows the client device 110 to interact with content and services hosted on the server(s) 104. In other words, the client device 110 interacts with the layered digital design system 102 without downloading the layered digital design system 102. To illustrate, in one or more implementations, the client device 110 access a software application supported by the server(s) 104.

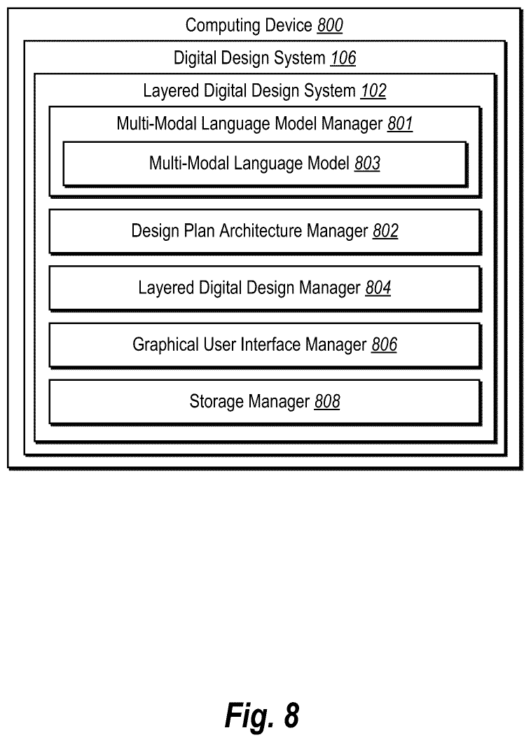

Indeed, in one or more embodiments, the layered digital design system 102 is implemented in whole, or in part, by the individual elements of the system environment 100. For instance, although FIG. 1 illustrates the layered digital design system 102 implemented or hosted on the server(s) 104, different components of the layered digital design system 102 are able to be implemented by a variety of devices within the system environment 100. For example, one or more (or all) components of the layered digital design system 102 are implemented by a different computing device or a separate server from the server(s) 104. Indeed, as shown in FIG. 1, the client device 110 includes the layered digital design system 102. Example components of the layered digital design system 102 will be described below with regard to FIG. 8.

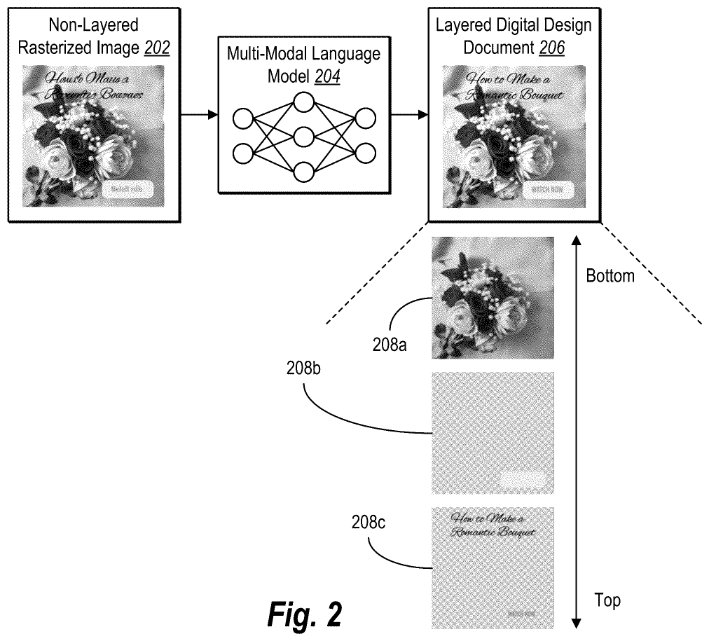

As mentioned above, the layered digital design system 102 generates layered designs from non-layered design reference images (e.g., raster format digital images). Specifically, as shown in FIG. 2, the layered digital design system 102 extracts background, objects, and text layers with optional further refinement. For instance, the layered digital design system 102 generates a layered representation of a digital image which significantly eases the design process by facilitating a variety of layer-based editing operations (e.g., modifications to specific layers such as modifying text and backgrounds).

As also mentioned above, the advancements and improvements in generative models have made design images more readily available in a rasterized pixel format. As also alluded to above, while the design images generated by generative models are visually compelling, they inherently lack editability. Specifically, even for simple operations such as horizontal flipping, text becomes unreadable since the text is not separated from the background or other elements portrayed in the rasterized pixel format. Even though some image editing tools exist to modify the attributes of elements, such an approach is significantly inferior compared to operations directly applied to a layer representation generated by the layered digital design system 102.

Despite the inherent limitations of rasterized designs, the availability and diversity of rasterized designs hold great value for creating layered designs. Specifically, the layered digital design system 102 leverages rasterized designs as a reference image to further create a layered digital design document. As shown in FIG. 2, the layered digital design system 102 accesses a non-layered rasterized image 202. Specifically, as mentioned above, the layered digital design system 102 utilizes one or more generative models to create the non-layered rasterized image 202 or the layered digital design system 102 receives the non-layered rasterized image 202 directly from a client device.

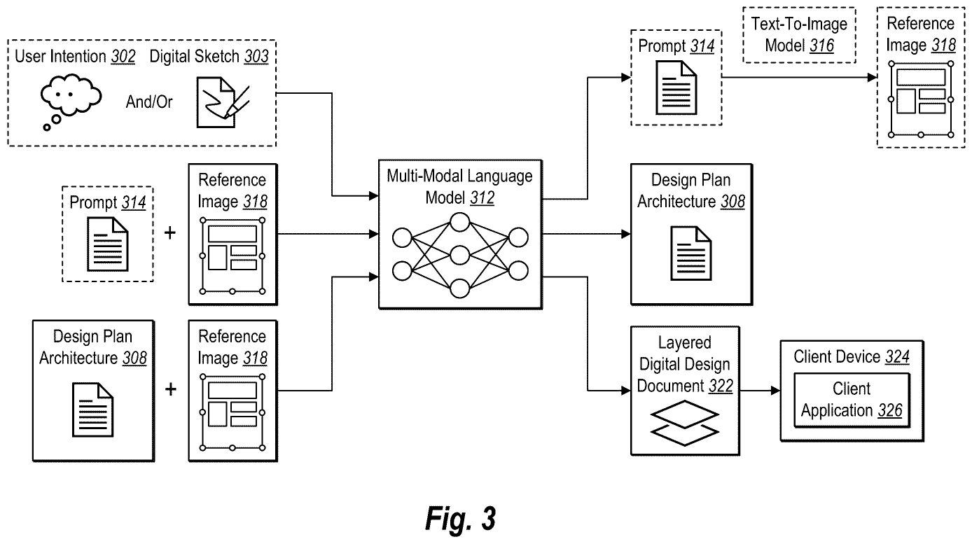

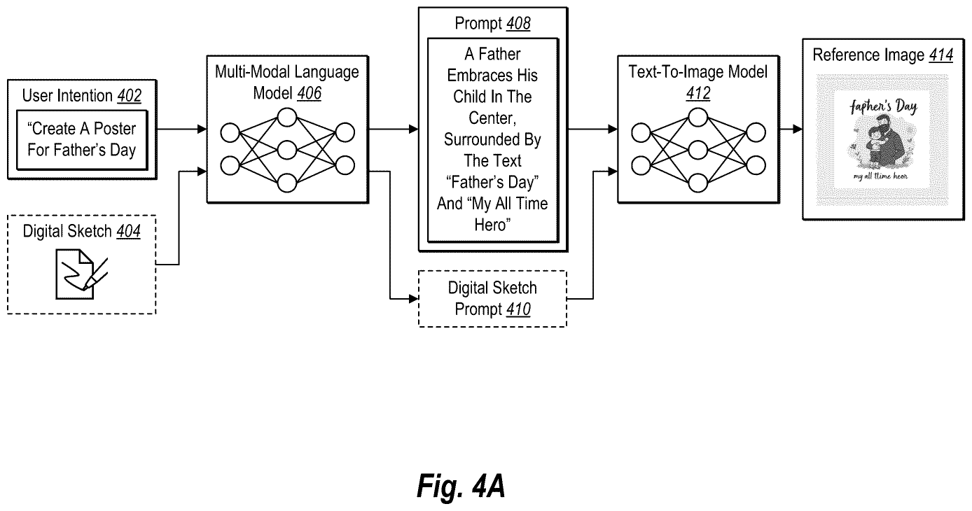

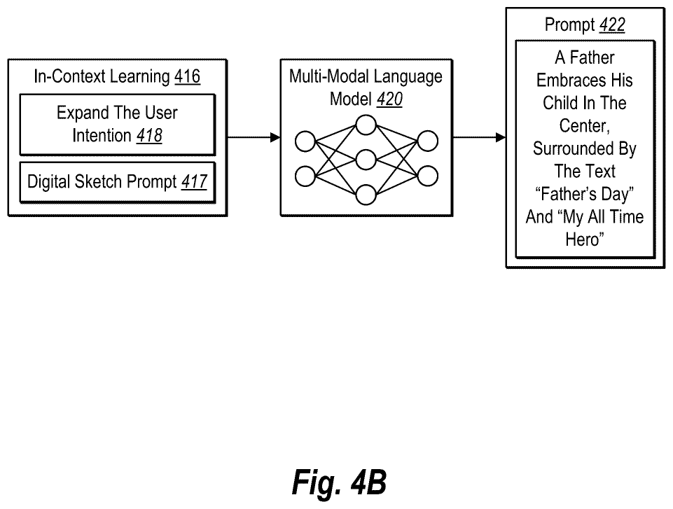

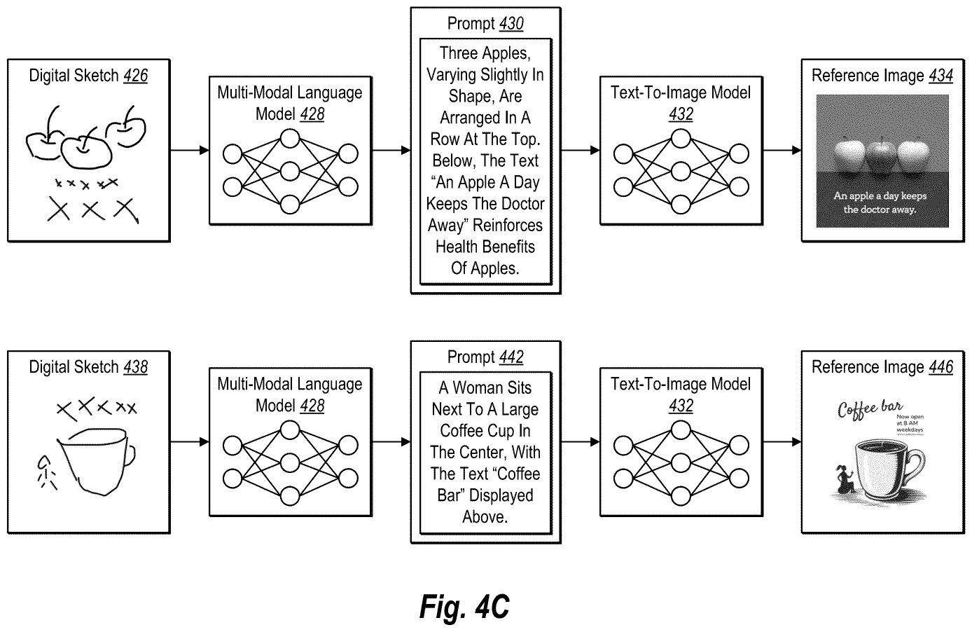

In one or more embodiments, a digital image includes various pictorial elements. In particular, the pictorial elements include pixel values that define the spatial and visual aspects of the digital image such as text and image objects. For example, the digital image is a rasterized image which includes a grid of pixels. In particular, the rasterized image includes a fixed resolution as determined by a number of pixels within the digital image. Additional details of generating the non-layered rasterized image 202 is given below in the description of FIGS. 3-4C.

Further, as shown in FIG. 2, the layered digital design system 102 utilizes a multi-modal language model 204 to process the non-layered rasterized image 202. As shown, from using the multi-modal language model to process the non-layered rasterized image, the layered digital design system 102 generates a layered digital design document. For example, a digital design document includes a file with various design properties. In particular, the digital design document includes digital design elements that fit within a dimension of the digital design document. For instance, the digital design document includes digital invitations, digital cards, digital fliers, digital posters, and various other digital files that include design elements such as text, images, and other artistic elements.

As shown in FIG. 2, the layered digital design system 102 generates a layered digital design document 206. Specifically, FIG. 2 shows the layered digital design document 206 includes a background layer 208a that portrays a background image, a middle layer 208b, and a text layer 208c. In one or more embodiments, the layered digital design document 206 refers to a document or file that is created to include design vector-based graphics (e.g., scalable shapes and paths that allows for high-resolution output at any size), illustrations, logos, and additional artwork/text elements. Specifically, the layered digital design system 102 allows a client device to manipulate/edit design elements within a digital design document via a digital design application.

For instance, the layered digital design system 102 allows a client device to edit/manipulate specific layers of the layered digital design document 206 without effecting other layers of a digital design document. To illustrate, the layered digital design system 102 receives edits to a background layer of a layered digital design document or to just a single foreground object of a layered digital design document. In one or more embodiments, a layer of a layered digital design document refers to different parts of a digital design, such as a background layer, and an object layer.

FIG. 3 illustrates an overview diagram of the layered digital design system 102 using the graphic design generation framework to create a layered digital design document from the reference image in accordance with one or more embodiments. For instance, FIG. 3 provides high-level details of each stage of the framework and the subsequent figures dive into specific details for each stage of the framework.

FIG. 3 shows the layered digital design system 102 optionally (e.g., as indicated by the dotted box) receiving a user intention 302 and/or a digital sketch 303 from a client device. In one or more embodiments, the user intention 302 refers to an underlying purpose of a user of a client device's request. Specifically, the user intention 302 includes at least one of digital text or the digital sketch 303 that indicates a specific question or request for the layered digital design system 102 to perform. The embodiment related to receiving a digital sketch is described in more detail below in FIG. 4C.

FIG. 3 shows that in one or more embodiments, the layered digital design system 102 uses a multi-modal language model 312 to process the user intention 302 and/or digital sketch to generate a prompt 314 that includes instructions to a generative model to generate a reference image 318. Specifically, in some embodiments, the layered digital design system 102 uses a text-to-image model 316 to generate the reference image 318 from the prompt 314. Specific examples regarding the layered digital design system 102 using the prompt 314 to generate the reference image 318 is given below in the description of FIGS. 4A-4B.

In one or more embodiments a machine learning model includes a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, random forest models, or neural networks (e.g., deep neural networks).

Similarly, a neural network includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a transformer neural network, a generative adversarial neural network, a graph neural network, a diffusion neural network, or a multi-layer perceptron. In some embodiments, a neural network includes a combination of neural networks or neural network components.

In one or more embodiments, a large language model includes or refers to one or more neural networks capable of processing natural language text to generate outputs that range from predictive outputs, analyses, or combinations of data within stored content items. In particular, a large language model can include parameters trained (e.g., via deep learning) on large amounts of data to learn patterns and rules of language for summarizing and/or generating digital content. Examples of large language model include Adobe Assistant AI, and GPT-based models.

In one or more embodiments, the layered digital design system 102 utilizes the multi-modal language model 312 to generate a layered digital design document 322 (e.g., that resembles the non-layered rasterized image 202 discussed in FIG. 2). Specifically, a multi-modal language model includes an artificial intelligence model to process and understand inputs from different data modalities (e.g., text and images). For example, the layered digital design system 102 utilizes a language model (e.g., a natural language model, a large language model, or a transformer-based model) as described in patent application Ser. No. 18/420,399, titled WEAKLY-SUPERVISED REFERRING EXPRESSION SEGMENTATION, filed on Jan. 23, 2024, which is fully incorporated by reference herein. Additional details of the multi-modal language model are also given below in the description of FIGS. 3-7.

In one or more implementations, the multi-modal language model is a vision-language model that understands both text and image data. For example, the vision-language model learns and utilizes a unified embedding space for image features and text features to simultaneously understand images and text, as well as relationships and interplay between the two. In some cases, the vision-language model includes various constituent networks, such as a text encoder that extracts or encodes text embeddings in the unified embedding space and a vision encoder that extracts or encodes image embeddings in the unified embedding space. In some embodiments, the vision-language model also includes a vision decoder for and a text decoder for mapping from the learned feature space of the vision-language model to the respective feature spaces of the foundational models. In one or more embodiments, the vision-language model is a transformer-based model.

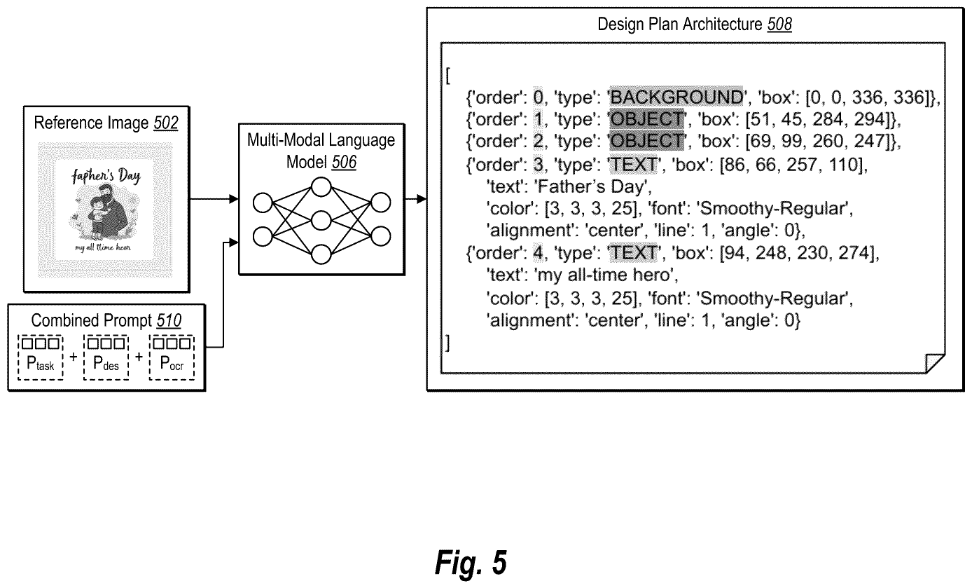

Further, FIG. 3 shows that the layered digital design system 102 processes the reference image 318 (e.g., and in some embodiments the prompt 314 along with the reference image 318) to generate a design plan architecture 308. Specifically, the design plan architecture 308 provides a bottom-top order of extracting design elements from the reference image 318. Additional details of the design plan architecture are given below in FIG. 5.

Moreover, the layered digital design system 102 uses the multi-modal language model 312 to process the design plan architecture 308 and the reference image 318 to generate the layered digital design document 322, which is then provided to a client device 324. Specifically, the layered digital design system 102 provides the layered digital design document 322 to a digital design application (e.g., client application 326) of the client device 324.

In one or more embodiments, the digital design application refers to a software application for creating and editing digital design documents (e.g., vector-based artwork). Specifically, the layered digital design system 102 provides a digital design application to create graphics, illustrations, and digital visual content, and to further edit digital design documents. For instance, the layered digital design system 102 provides a digital design application with various drawing and illustration tools to create/manipulate shapes, paths, freehand draw, move objects (e.g., text or visual objects), adjust the size of objects, edit text object elements, change background elements, change color attributes, font attributes, color gradients, and layering/organization of the digital design document.

FIG. 4A illustrates an example diagram of the layered digital design system 102 generating a reference image using a text-to-image model in accordance with one or more embodiments. For example, FIG. 4A shows the layered digital design system 102 receiving a user intention 402. As mentioned above, the user intention 402 refers to an underlying purpose of a user of a client device's request and typically includes a general request. For example, the user intention 402 includes a general request from the client device to create a digital design document for father's day.

For instance, as part of the aforementioned user intention, a user textually describes the request and/or provide a rough digital sketch of the request. In one or more embodiments, the layered digital design system 102 receives digital text as part of the user intention 402. In particular, the layered digital design system 102 receives digital text from a client device that textually describes content to be included within a layered digital design document generated by the layered digital design system 102. For instance, the digital text describes specific parameters to be included in the layered digital design document generated by the layered digital design system 102.

As also shown in FIG. 4A, in some embodiments the layered digital design system 102 optionally receives a digital sketch 404. In one or more embodiments, the digital sketch 404 refers to a visual input to guide the layered digital design system 102 to generate the layered digital design document. For example, the digital sketch 404 includes a digital image (e.g., a screenshot, a screen snippet, an input sketch to the digital design application, or a client device captured digital image). For instance, in some embodiments, the layered digital design system 102 provides an option for the client device to visually indicate how a layered digital design document should be structured. In other words, for a father's day poster (e.g., digital design document), a client device submits a rough digital sketch of how an object (e.g., the father) is positioned and how text elements are positioned relative to the object.

Further, FIG. 4A shows the layered digital design system 102 processing the user intention 402 (e.g., of create a poster for Father's day) using the multi-modal language model 406 to generate a prompt 408. In one or more embodiments, a prompt refers to a set of instructions used to elicit a response from the text-to-image model 412. Specifically, the layered digital design system 102 generates the prompt 408 that includes a set of detailed instructions for the text-to-image model 412 to generate a digital design document.

For example, the layered digital design system 102 sends as input the user intention 402 and/or the digital sketch 404 (e.g., a broader description of a task) to the multi-modal language model 406 and instructs the multi-modal language model 406 to expand the user intention 402 (e.g., add detail) and/or the digital sketch 404. In some embodiments, the layered digital design system 102 provides the user intention 402 and/or the digital sketch 404 along with a set of positive examples to the multi-modal language model 406. For instance, the positive examples include input user intentions (e.g., broader descriptions of a digital design document) and corresponding outputs that include much more detailed descriptions of creating a digital design document.

Moreover, the layered digital design system 102 instructs the multi-modal language model 406 to expand on the given user intention based on the given examples. To illustrate, from a user intention of “father's day poster” the layered digital design system 102 utilizes the multi-modal language model 406 to generate the prompt 408 of [a father embraces his child in the center, surrounded by the text “Father's Day” and “My All Time Hero”].

Furthermore, the prompt includes a description of a task. In one or more embodiments, a description of a task refers to a purpose of the prompt 408. Specifically, the layered digital design system 102 generates the prompt 408 that includes the description of a task that includes an overarching goal or purpose of the prompt 408. For example, as part of the prompt, “a father embraces his child in the center, surrounded by the text ‘Father's Day’ and ‘My All Time Hero’” the prompt also includes the description of the task as “a Father's day poster” (e.g., the initially submitted user intention).

As shown in FIG. 4A, in some embodiments, the layered digital design system 102 receives the digital sketch 404 along with the user intention 402 and generates a digital sketch prompt 410. Specifically, the digital sketch prompt 410 refers to a textual description of what the digital sketch 404 conveys. Moreover, as shown in FIG. 4A, the layered digital design system 102 uses a text-to-image model 412 to generate a reference image 414 from the prompt 408 and/or the digital sketch prompt 410.

In one or more embodiments, the text-to-image model 412 refers to an artificial intelligence model that generates a digital image from a textual description of the digital image. Specifically, the layered digital design system 102 utilizes the text-to-image model 412 to generate the reference image 414 from the prompt 408. For example, the layered digital design system 102 uses the text-to-image model 412 that leverages generative methods to convert text input into visual content. In particular, the layered digital design system 102 uses the text-to-image model 412 to encode textual input (e.g., from the prompt) into a numerical representation that captures the meaning and key attributes of the text and further uses the encoded representations to generate an image (e.g., via a generative adversarial network or a diffusion model).

In one or more embodiments, the reference image 414 refers to a global reference image that includes a digital design. For example, the layered digital design system 102 uses the reference image 414 throughout the process of generating a layered digital design document. Specifically, the reference image 414 refers to a digital image (e.g., rasterized digital image, or in other words a digital image without any layer data) that the layered digital design system 102 uses to further generate a layered digital design document. For instance, the layered digital design system 102 intelligently transforms a non-layered digital image (e.g., the reference image 414) into a layered digital image using the multi-modal language model 406. To illustrate, the reference image 414 contains various design elements (e.g., in pixel format) such as foreground objects, background objects, text objects, and a background image.

As mentioned, the reference image 414 includes a digital design. In one or more embodiments, a digital design refers to elements within a document that include illustrations, logos, artwork, and text. Specifically, a digital design further includes a document with various design elements organized and manipulated in a manner to fulfill a user intention. For instance, the layered digital design system 102 generates the reference image 414 that includes the digital design, and the elements of the digital design in the reference image 414 is static as it is part of a non-layered raster image.

FIG. 4B illustrates an example diagram of the layered digital design system 102 using in-context learning to generate a prompt from the user intention in accordance with one or more embodiments. As shown in FIG. 4B, the layered digital design system 102 utilizes in-context learning 416 to generate a prompt 422. Specifically, in-context learning refers to a process where a multi-modal language model 420 learns or adapts to new information based on the specific context it is provided, without requiring express retraining or fine-tuning. For instance, as shown in FIG. 4B, the layered digital design system 102 uses in-context learning 416 to perform an act 418 of expanding on a user intention (e.g., the user intention 402 discussed in FIG. 4A).

To illustrate, the layered digital design system 102 provides the following as the in-context learning 416 for the multi-modal language model:

Your task is to expand the original prompt into a detailed one. I will give you some examples.
[Input 1] create an advertisement for a fish market with a special offer of a 20% discount on
seafood.
[Output 1] A bustling fish market under a vibrant morning sky. Local vendors display an array
of fresh, glistening seafood, from ruby-red lobsters to iridescent, silver fish. A large, colorful
banner hangs overhead, proudly announcing a special offer with 20% discount on all seafood.
The air is thick with excitement and the irresistible aroma of the ocean.
[Input 2] Create a business card for a flower shop with a focus on blue tulips.
[Output 2] An elegant business card lying on a white marble surface. The card is adorned with
a captivating watercolor illustration of rich, azure blue tulips, their petals opening up to reveal
layers of deep and light shades of blue. The shop's name is written in a sophisticated cursive
font at the center, while contact details are subtly placed at the bottom right corner.
Now based on the given prompt “Design a cutting-edge logo for a real estate agency named
Golden Home.”, please expand it into a detailed one.

In other words, the layered digital design system 102 uses in-context learning to provide various examples of user intentions and a corresponding prompt, where the corresponding prompt is much more detailed than the user intention. Specifically, the in-context learning 416 allows the layered digital design system 102 to optimize the multi-modal language model 420 to expand upon a received user intention at inference-time.

As shown in FIG. 4B, in response to the in-context learning 416, the layered digital design system 102 uses the multi-modal language model 420 to expand upon a user intention (e.g., such as the user intention 402 discussed in FIG. 4A). Specifically, FIG. 4B shows the layered digital design system 102 generating the prompt 422 that reads [A father embraces his child in the center, surrounded by the text “Father's Day” and “My All Time Hero”].

In one or more embodiments, the layered digital design system 102 receives an additional digital sketch (e.g., similar to a digital sketch as discussed above in FIG. 4A). For instance, the layered digital design system 102 receives an additional digital sketch and generates a digital sketch prompt 417 using the in-context learning 416. To illustrate, the layered digital design system 102 generates the digital sketch prompt 417 that reads:

You will be provided with a sketch that you need to analyze and describe meticulously, paying
close attention to each detail depicted. Identify and describe where each object is located within
the sketch. Note that the “xxx” symbols on the image are placeholders for text, which you should
replace with appropriate content. Your description should capture the layout and the thematic
elements of the design. As a reference information, this image is about “Eating more apples is
good for your health”.

FIG. 4C illustrates an example diagram of the layered digital design system 102 using a digital sketch to generate a prompt to further generate a reference image in accordance with one or more embodiments. In some embodiments, the layered digital design system 102 only receives a digital sketch (e.g., does not receive a user intention). For example, FIG. 4C shows the layered digital design system 102 receiving a digital sketch 426 that depicts a rough drawing of apples and x's indicating where text should be placed. Specifically, FIG. 4C shows the layered digital design system 102 utilizing a multi-modal language model 428 to generate a prompt 430 for the digital sketch 426.

To illustrate, the layered digital design system 102 generates the prompt 430 that reads [Three apples, varying slightly in shape, are arranged in a row at the top. Below, the text “An apple a day keeps the doctor away” reinforces health benefits of apples]. Additionally, FIG. 4C shows that from the prompt 430, the layered digital design system 102 further utilizes a text-to-image model 432 to generate a reference image 434 that conforms with the description of the prompt 430.

Moreover, FIG. 4C illustrates the layered digital design system 102 receiving a digital sketch 438 that depicts a rough drawing of a person next to a cup and x's indicating where text should be placed. Specifically, FIG. 4C shows the layered digital design system 102 utilizing the multi-modal language model 428 to generate a prompt 442 for the digital sketch 438.

To illustrate, the layered digital design system 102 generates the prompt 442 that reads [A woman sits next to a large coffee cup in the center, with the text “Coffee Bar” displayed above]. Furthermore, FIG. 4C shows that from the prompt 442, the layered digital design system 102 uses a text-to-image model 432 to generate a reference image 446 that conforms with the description of the prompt 442.

FIGS. 4A-4C show the layered digital design system 102 using the multi-modal language model to process data in the text domain and the visual domain. In one or more embodiments, the layered digital design system 102 utilizes a text encoder to process a prompt. In particular, the text encoder includes a component of a neural network to transform textual data (e.g., the prompt) into a numerical representation. For instance, the layered digital design system 102 utilizes the text encoder to transform the prompt into a text encoding (e.g., text tokens).

Further, the layered digital design system 102 utilizes the text encoder in a variety of ways. For instance, the layered digital design system 102 utilizes the text encoder to i) determine the frequency of individual words in the prompt (e.g., each word becomes a feature vector), ii) determines a weight for each word within the prompt to generate a text vector that captures the importance of words within a prompt, iii) generates low-dimensional text vectors in a continuous vector space that represents words within the prompt, and/or iv) generates contextualized text vectors by determining semantic relationships between words within the prompt.

In one or more embodiments, the layered digital design system 102 generates text tokens from a prompt. For example, the layered digital design system 102 utilizes a text encoder to generate a representation of the prompt for a machine learning task. Specifically, a single text token refers to a word, a sub-word, or a character (e.g., “the,” “on,” “cat,” “t,” “showcasing,” “show,” “casing,” etc.). Furthermore, the layered digital design system 102 generates tokens representing special meaning or purposes such as the beginning or an end of a sentence.

In one or more embodiments, an image encoder is a neural network (or one or more layers of a neural network) that extract features relating to digital images (e.g., the reference image). In some cases, an image encoder refers to a neural network that both extracts and encodes features from a digital image (e.g., a digital sketch). For example, an image encoder can include a particular number of layers including one or more fully connected and/or partially connected layers of neurons that extract image patches from the reference image and encode localized features of the reference image. To illustrate, in one or more embodiments, the layered digital design system 102 generates an image embedding that represents a complete frame of a digital image.

In one or more embodiments, the layered digital design system 102 utilizes the image encoder to generate image embeddings. In some embodiments, the image embeddings include a numerical representation (e.g., a vector) of the digital sketch. For instance, the image embeddings capture features and properties of the reference image. To illustrate, the image embeddings include semantic information such as the presence of objects, shapes, and spatial relationships.

In one or more embodiments, the layered digital design system 102 transforms the image embeddings into visual tokens. For example, the layered digital design system 102 utilizes a tokenization model to patchify the image embeddings. Specifically, a tokenization model converts the image embedding into smaller patches or grids that are treated as individual tokens for further processing (e.g., adding noise and then denoising).

For instance, the layered digital design system 102 utilizes patchification to handle high-dimensional image data efficiently. To illustrate, the layered digital design system 102 flattens each patch of the image embedding (e.g., into a single dimension vector), converts the flattened patch into a lower-dimensional representation, and maps the flattened lower-dimensional patch into a fixed-length feature vector. Accordingly, the layered digital design system 102 treats the flattened fixed-length feature vector as a visual token and utilizes the diffusion transformer model to process the visual token.

Moreover, in some embodiments, the layered digital design system 102 adds positional encodings to each patch (e.g., visual token) to encode spatial information about where the patch belongs in a digital image. Furthermore, in some embodiments, the layered digital design system 102 generates spatial encodings for natural language tokens (e.g., text and image tokens) to represent a spatial location of the various design elements in the reference image.

In one or more embodiments, the layered digital design system 102 selects a set of image patches from the digital sketch. In particular, the layered digital design system 102 generates the set of image patches by sub-dividing the digital sketch into smaller regions. For instance, the layered digital design system 102 sub-divides the digital sketch into patches based on a predetermined resolution (e.g., 256×256), where each patch represents localized regions within the digital sketch. In some embodiments, an image patch of the set of image patches does not share any pixel values with other image patches. In some embodiments, an image patch of the set of image patches overlaps with pixel values of an adjacent image patch. Accordingly, in one or more embodiments, the layered digital design system 102 sub-divides the digital sketch into image patches where some of the image patches do not overlap with pixel values of other image patches and some of the image patches do overlap with pixel values of other image patches.

Although the above description relates to the layered digital design system 102 utilizing an image encoder for the digital sketch, in one or more embodiments, the layered digital design system 102 also uses the image encoder to generate image embeddings and visual tokens for the reference image. Specifically, the layered digital design system 102 utilizes the image encoder for processing the reference image to generate a design plan architecture (e.g., which is discussed in more detail below).

FIG. 5 illustrates an example diagram of the layered digital design system 102 generating a design plan architecture from a reference image and additional details of generating a combined prompt in accordance with one or more embodiments. As shown, the layered digital design system 102 processes a reference image 502 and in some embodiments, a combined prompt 510 using a multi-modal language model 506.

For instance, the reference image 502 contains design elements (e.g., in pixel format), which the layered digital design system 102 extracts to create a layered digital design document. In one or more embodiments, design elements of the reference image 502 refers to individual components or parts of the reference image 502 that make up the visual aspects of the reference image 502. Specifically, the design elements include textual objects, visual objects, structure (e.g., organization), and style (e.g., colors, font styles size of various elements). For example, in the aggregate, the design elements make up the layout (e.g., arrangement of content and visual elements), typography (e.g., style and appearance of text), and color scheme of the reference image 502.

In one or more embodiments, the reference image 502 includes objects. For example, an object includes a collection of pixels in the reference image 502 that depicts a person, place, text, or thing. To illustrate, in some embodiments, an object includes a person, an item, a natural object (e.g., a tree or rock formation) or a structure depicted in a digital image. For instance, an object can include text that depicts a word or a series of words. In some instances, an object refers to a plurality of elements that, collectively, can be distinguished from other elements depicted in a digital image. For example, in some instances, an object includes a collection of buildings that make up a skyline. In some instances, an object more broadly includes a (portion of a) foreground or other element(s) depicted in a digital image as distinguished from a background. Furthermore, in the reference image, the objects are rasterized objects.

In one or more embodiments, the text object element refers to a digital representation of text as a collection of pixels in the reference image 502. Specifically, the text object element includes actual text or a string of characters (e.g., letters, numbers, punctuation, and symbols) as well as font style and weight (e.g., typeface and weight of the text such as bold, italic, underlined).

Moreover, the text object element includes a size, a color, alignment, wrapping elements (e.g., wrapped around other visual objects), and other formatting elements (e.g., hyperlinks, bullet points, numbered lists, etc.). To illustrate, the text object element in the reference image 502 is a rasterized object and thus it is not editable as it would be if it was a vectorized object.

In one or more embodiments, the foreground object refers to a digital representation of a visual element as a collection of pixels in the reference image. Specifically, the foreground object refers to an object or element in the reference image 502 that appears to be or is portrayed as being in the front of a scene or composition of the reference image. In other words, the foreground object appears to be closest to the viewer of the reference image 502.

In one or more embodiments, a background image refers to a digital representation of a visual element as a collection of pixels in the reference image 502 that appears to lie behind a main subject. Specifically, the background image provides a setting or visual environment for foreground objects and creates depth and perspective in the reference image 502.

In one or more embodiments, a combined prompt 510 refers to set of instructions used to elicit a response from the multi-modal language model 506. In contrast with the prompt described above, the combined prompt 510 specifically includes a description of a task (e.g., father's day poster), a description (e.g., “a father embraces his child in the center, surrounded by the text ‘Father's Day’ and ‘My All Time Hero’), and optical character recognition data. Specifically, the layered digital design system 102 adds together or concatenates tokens relating to the description of the task, the description, and the optical character recognition data to generate the combined prompt 510.

In one or more embodiments, the layered digital design system 102 utilizes an optical character recognition model to extract machine-readable text from the reference image. Specifically, the layered digital design system 102 uses an optical character recognition model that leverages machine learning, pattern recognition, and artificial intelligence to interpret portrayed text within the reference image 502. Moreover, the layered digital design system 102 uses the optical character recognition model to transform the identified text into a format that is editable and processable by computing devices. To illustrate, the layered digital design system 102 identifies text in the reference image 502 and extracts support optical character recognition data from the reference image (e.g., the layered digital design system 102 extracts optical character recognition data which is important for correcting nonsensical text images). For instance, the layered digital design system 102 extracts bounding box coordinates representing coordinates of a region in the reference image 502 where text has been detected.

Herein is provided additional prompt examples of the layered digital design system 102 generating a combined prompt. To illustrate, for a reference image generated by a generative model (e.g., an AI model), in some embodiments, the layered digital design system 102 uses the following templates:

Parse and refine the attributions of text. Parse the objects, and backgrounds in the graphic design
image. The caption of the image is The “Red White Bold Type” beverage label is a striking
visual feast, designed to capture the essence of the boldness and purity. With vivid red and
pristine white color scheme, the label features bold, assertive typography that commands
attention. This design not only reflects the vibrant and robust flavors of the beverage but also
appeals to consumers with its clean, contemporary aesthetic, making it a standout choice on any
shelf. Support OCR results are: [[(22, 64, 228, 132], [(21, 126, 311, 211)], [(82, 208, 119, 215)]].

Parse and refine the attributions of text. Parse the objects, and backgrounds in the graphic design
image. The caption of the image is the Facebook page cover for a modern record store should
be a vibrant and engaging visual and encapsulates the essence of music and contemporary
design. It might feature a collage of iconic album colors, interspersed with sleek, modern graphic
elements that convey the store's cutting-edge aesthetic. Support OCR results are: [[(214, 89,
299, 120)], [(41, 86, 110, 138)], [(18, 121, 59, 176)], [(195, 121, 317, 147)], [(209, 175, 310,
197)], [(224, 197, 290, 219)], [94, 219, 106, 237)], [(215, 232, 300, 246)]].

Further, for a reference image received directly from a client device, in some embodiments, the layered digital design system 102 uses the following templates:

Parse the attributions of text, objects, and backgrounds in the graphic design image. Support
OCR results are: [[‘THE COOD’ , (85, 15, 228, 51)], [‘CREATIVE’, (88, 51, 232, 85)],
[‘STUDIO’, (84, 83, 196, 120], [‘2701 Willow’, (85, 218, 158, 236)], [‘Charles,’, (83, 235, 135,
253)], [‘aneLake’, (122, 228, 177, 243)], [‘(555)555-0100’, (85, 265, 174, 282)], [‘@the-
goodstudio’, (86, 297, 180, 312], [‘www.thegoodstudio.site.con’, (85, 310, 237, 324)]]

Parse the attributions of text, objects and backgrounds in the graphic design image. Support
OCR results are: [[‘CLEARANCE’, (19, 213, 318, 255)], [‘SALE’, (14, 256, 136, 297)],
[‘2701WillowOaks', (203, 272, 300, 287)], [‘Lane Lake Charles, LA’, (203, 284, 321, 298)]]

Moreover, for a reference image with no text within the initial image, in some embodiments, the layered digital design system 102 uses the following templates:

Add text on the background. And parse the overall graphic design. The caption of the image is
floral green and pink wellness institute business card.

Add text on the background. And parse the overall graphic design. The caption of the image is
the logo for Green Saw Carpenters captures the essence of the brands commitment to sustainable
building practices and skilled craftsmanship. It features a stylized green saw blade, intricately
designed to resemble both a leaf and a carpentry tool, symbolizing the fusion of nature and
construction.

As shown in FIG. 5, by processing the reference image 502 and the combined prompt 510, the layered digital design system 102 generates a design plan architecture 508. In one or more embodiments, the design plan architecture 508 refers to a design plan that instructs the multi-modal language model 506 how to construct a layered digital design document. Specifically, the layered digital design system 102 generates the design plan architecture 508 that is based on the reference image 502.

In one or more embodiments, the layered digital design system 102 utilizes a coordinate map to generate a spatial embedding of a token to further generate the design plan architecture 508. For instance, the layered digital design system 102 utilizes a positional encoding function for a token (e.g., corresponding to an image patch or corresponding to a text object element, or some other design element in the reference image). Moreover, the layered digital design system 102 labels the token (e.g., assigns the token) to a space on the coordinate map to generate a spatial encoding for the token. Furthermore, in some embodiments, the layered digital design system 102 generates the design plan architecture 508 by processing the tokens (e.g., of the reference image 502 and the combined prompt 510) along with the spatial encodings.

In one or more embodiments, the design plan architecture 508 is generated by the layered digital design system 102 in a JSON structure that indicates different layers of different types and attributes in the reference image 502. Specifically, the layered digital design system 102 generates design plan architecture 508 as text tokens which represent the layer structure of the reference image 502.

In some embodiments, the layered digital design system 102 utilizes the multi-modal language model 506 to predict a JSON string (e.g., rather than natural language), where the JSON string conforms with a predefined structure of graphic digital design layers (e.g., background layer, object layer, text layer, etc.). For instance, the layered digital design system 102 generates a JSON string that captures vector attributes (e.g., color, font, etc.) to more holistically represent structural information of the reference image 502 as a text sequence (e.g., JSON format).

In some embodiments, the design plan architecture 508 details the placement of objects within the reference image 502 and instructs the multi-modal language model 506 in extracting design elements from the reference image 502. Moreover, the design plan architecture 508 includes details such as rendering attributes of text to facilitate the construction of text layers in a layered digital design document. In particular, the design plan architecture 508 includes a bottom-top order of building the layered digital design document based on the reference image 502.

To illustrate, in some embodiments, the design plan architecture 508 includes a sequence of dictionaries, each representing the attributes of elements in the reference image 502. For instance, the design plan architecture includes the design elements arranged in a bottom-top order to facilitate further object extraction. Specifically, the design plan architecture 508 includes JSON output of bounding boxes for both background and foreground objects and detailed text attributes, such as bounding boxes, content, color, font, alignment, line count, and angle. In one or more embodiments, color elements of the design plan architecture 508 refers to a visual appearance of the text based on a color applied to it. For instance, for the color attributes (R, G, B, A), the layered digital design system 102 maps the ([0, 255] range to [0, 25]).

In one or more embodiments, a font element refers to a specific typeface and/or style of text. Specifically, a font element refers to a font family, a weight, and a size of the text. In one or more embodiments, a content attribute of the design plan architecture 508 refers to actual textual information or characters that the text object contains. Specifically, the content attribute includes a string of characters.

In one or more embodiments, a bounding box of the design plan architecture 508 refers to an area that surrounds a text object element. Specifically, a bounding box defines a space occupied by the text, including any associated margins around the text. For instance, the layered digital design system 102 determines the bounding box to assist in alignment, positioning, and determining dimensions of a text object element. To illustrate, a bounding box includes coordinates such as, top-left, top-right, bottom-left, and bottom-right). For instance, the layered digital design system 102 normalizes bounding box coordinates in the range of [0, 336].

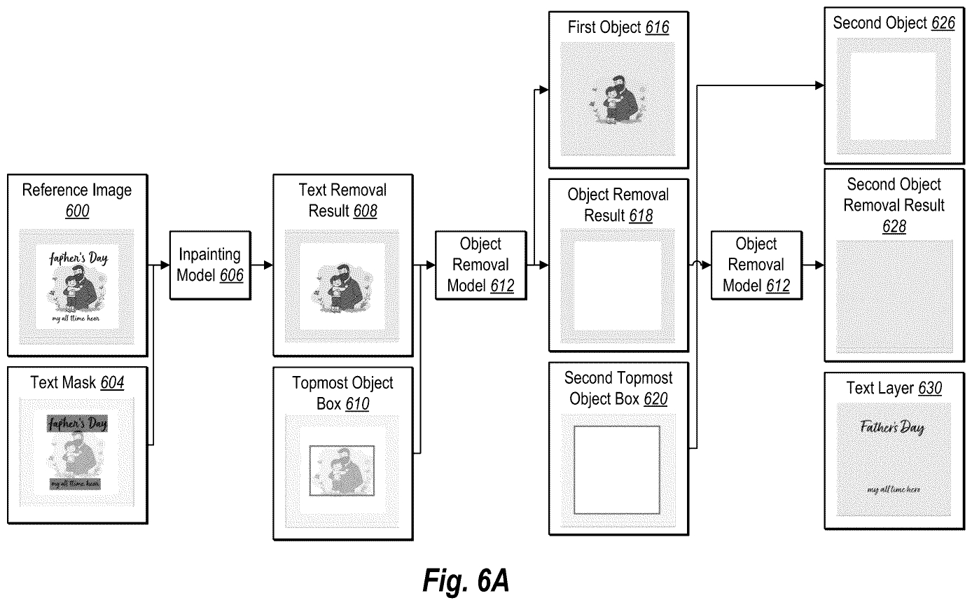

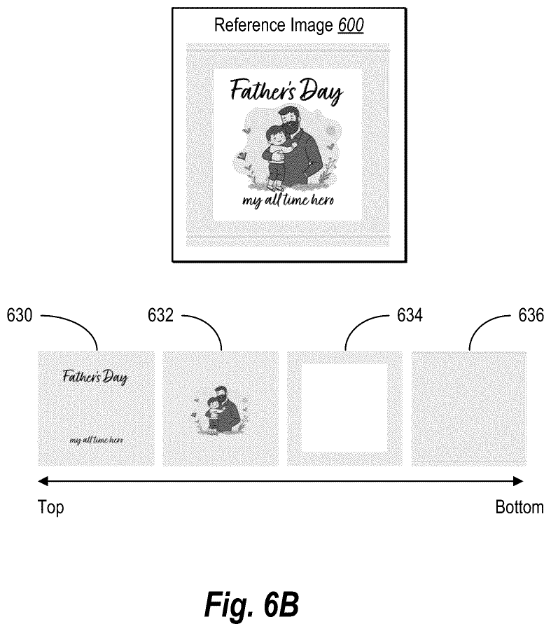

FIG. 6A illustrates an example diagram of the layered digital design system 102 iteratively removing design elements from a reference image to generate multiple layers from a reference image in accordance with one or more embodiments. For example, guided by the design plan architecture discussed above, the layered digital design system 102 processes a reference image 600 with text removal and then with progressive foreground object extraction (e.g., using a segmentation model and an object removal model), obtaining the background image in the end.

As just mentioned, FIG. 6A shows the layered digital design system 102 accessing the reference image 600 and a text mask 604 of the reference image 600. Specifically, the text mask partitions the detected text portions of the reference image 600 as dictated by the design plan architecture. For instance, the design plan architecture indicates the bounding box coordinates of the text objects, the alignment, the line, and the angle. For example, the layered digital design system 102 utilizes a segmentation model to segment the portions of the reference image 600 that correspond to the text objects.

In one or more embodiments, a segmentation model refers to a computer vision machine learning model for partitioning or separating an image into distinct regions/segments. Specifically, the layered digital design system 102 utilizes a segmentation model to segment an image (e.g., the reference image) into distinct portions, where each portion represents a specific object (e.g., background image, text object element, foreground object element), feature, or area of interest. For instance, the layered digital design system 102 labels pixels in the reference image according to a corresponding class (e.g., text object).

Moreover, as shown in FIG. 6A, the layered digital design system 102 utilizes an inpainting model 606 to remove the text objects as identified by the text mask 604. Specifically, in some embodiments, the layered digital design system 102 utilizes the inpainting model 606 to fill in missing parts of the reference image 600 based on removing the text mask 604 from the reference image 600. For instance, the layered digital design system 102 utilizes the inpainting model 606 to predict and generate the missing or altered pixels in a manner that blends in with and matches the consistency of the rest of the reference image 600. For example, the layered digital design system 102 uses an inpainting model specifically trained for text removal to erase text, recognizing that text regions are commonly placed on the top layer for enhanced readability.

As shown in FIG. 6A, based on a text removal result 608, the layered digital design system 102 focuses on object removal. Specifically, the layered digital design system 102 sequentially extracts a topmost element according to the order outlined in the design plan architecture, to extract (e.g., using the segmentation model) the foreground object and obtain its corresponding mask. For instance, FIG. 6A shows the layered digital design system 102 identifying a topmost object box 610.

Furthermore, FIG. 6A shows the layered digital design system 102 utilizing an object removal model 612 to remove the topmost object box 610 identified according to the design plan architecture (e.g. and segmented using a segmentation model) which generates an object removal result 618 and further generates a first object 616 (e.g., the object that corresponds with the topmost object box 610). Specifically, the layered digital design system 102 feeds the mask and an intermediate image (e.g., intermediate relative to the reference image 600) to the object removal model to remove the object.

Additionally, FIG. 6A shows that the layered digital design system 102 further identifies a second topmost object box 620. Specifically, the layered digital design system 102 utilizes an object removal model to process the object removal result 618 and remove a second object 626 (e.g., segmented using a segmentation model) to generate second object removal result 628 (e.g., the background image). FIG. 6A shows the layered digital design system 102 generating a second object 626 as a layer, the second object removal result 628 as a layer, and a text layer 630. As alluded to, the layered digital design system 102 iteratively executes object removal if multiple objects are detected in the design plan architecture and ends with the background image.

FIG. 6B shows that as a result of extracting the design elements from the reference image, the layered digital design system 102 generates a layered digital design document from the reference image 600. Specifically, FIG. 6B shows that the layered digital design system 102 extracts multiple layers from the reference image 600 that include the text layer 630 (e.g., at the top), an object layer 632 (e.g., of the father embracing the son that corresponds to the first object 616), a border layer 634 (e.g., the corresponds with the second object 626), and a background image layer 636 (e.g., that corresponds with the second object removal result 628).

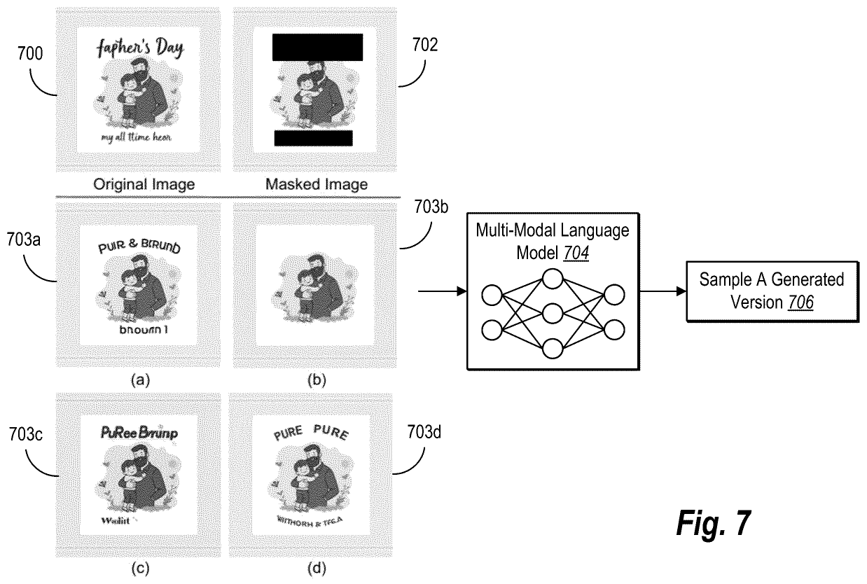

FIG. 7 illustrates an example diagram of the layered digital design system 102 generating a plurality of results at each iterative stage of removing a design element in accordance with one or more embodiments. As discussed above in FIG. 6A, the layered digital design system 102 iteratively removes design elements from the reference image. At each of these stages, the layered digital design system 102 generates multiple results of removing a design element according to the design plan architecture. For instance, the layered digital design system 102 generates multiple results and uses a multi-modal language model 704 to sample one of the results.

In one or more embodiments, the layered digital design system 102 generates diverse results at each stage of removal according to the design plan architecture. Specifically, to ensure consistent quality, the layered digital design system 102 designs a set of results (e.g., a questionnaire) that enables the multi-modal language model 704 to conduct a result selection.

As shown in FIG. 7, the layered digital design system 102 accesses a reference image 700 and at a step of removing design elements (e.g., text objects) in a masked image 702, the layered digital design system 102 generates a first result 703a, a second result 703b, a third result 703c, and a fourth result 703d. Specifically, the layered digital design system 102 trains the multi-modal language model 704 to select the highest quality result. As shown in FIG. 7, the layered digital design system 102 utilizes the multi-modal language model 704 to perform an act 706 of sampling a generated version to use in the next iterative phase of removing an additional design element according to the design plan architecture.

For instance, during the training phase, the layered digital design system 102 presents the multi-modal language model 704 with a ground truth of a design element removal alongside three generated removal results. In doing so, the layered digital design system 102 optimizes the multi-modal language model 704 to select the highest quality option (e.g., the ground truth).

To illustrate, during training, the layered digital design system 102 provides the following text prompt the multi-modal language model 704 along with the results:

The provided image appears to show four different results of a graphic design removal task. The
first row displays the original image on the left and the masked image on the right. The second
and third rows exhibit the corresponding outcomes of the graphic design removal. To evaluate
the effectiveness of the results, the key criteria are 1) the overall harmony and coherence of the
image, 2) the purity and cleanness of the background, and 3) the absence of any additional
extraneous elements. Based on these criteria, please select the option (a, b, c, or d) that represents
the best result.

FIGS. 1-7 provide various details of the layered digital design system 102 generating a layered digital design document. The following description provides details regarding preparing/optimizing a multi-modal language model and how the results of the layered digital design system 102 compare with existing systems. In one or more embodiments, the layered digital design system 102 uses digital design template metadata (e.g., obtained from digital design applications) to train the multi-modal language model. Specifically, the layered digital design system 102 uses a digital design dataset that includes 39,233 samples for training and 492 samples for validations. For instance, the layered digital design system 102 uses the digital design dataset that includes a diverse array of designs, including posters, books, covers, and advertisements. Moreover, the digital design dataset used to train the multi-modal language model also includes a description (e.g., a description of the contents of the sample design) that accompanies each sample design.

In one or more embodiments, the layered digital design system 102 uses multiple types of sample designs to train the multi-modal language model. Specifically, the layered digital design system 102 uses original designs created by client devices (e.g., such that the multi-modal language model conducts text de-rendering by directly parsing the original designs), designs with nonsensical text, and background without text.

For instance, the layered digital design system 102 uses designs with nonsensical text and employs a stable diffusion inpainting model to inpaint text areas with inpainting strength randomly set between 0.5 and 0.7, which leads to the generation of nonsensical text by the model. Moreover, the layered digital design system 102 uses the range of 0.5-0.7 because strength outside this range leads to either insufficient or excessive inpainting changes, which hinder effective training. Furthermore, inpainting results may not strictly maintain the original text style and have potential variations in color and font.

Furthermore, the layered digital design system 102 uses background without text designs by removing all text from a design and using only the background image as a reference. In doing so, the layered digital design system 102 challenges the multi-modal language model to add text in appropriate contexts and locations. Specifically, the layered digital design system 102 organizes the elements of the sample design without text into a list of dictionaries and converts them into a string format for training the multi-modal language model.

In one or more embodiments, the layered digital design system 102 uses the same training objective for the three aforementioned design samples. For instance, the layered digital design system 102 trains the multi-modal language model for result selection for both text and object removal tasks (e.g., as discussed above, the layered digital design system 102 uses the removal model to generate three different results). Specifically, the layered digital design system 102 combines the results with ground truth designs and randomly shuffles the designs to construct a questionnaire dataset (e.g., to train the multi-modal language model to select the best design sample). To illustrate, the layered digital design system 102 prepared 156,932 samples that include 39,233 training samples for each of the three different types of design samples (e.g., reference images) and the questionnaire dataset.

In one or more embodiments, the layered digital design system 102 trains the multi-modal language model on the aforementioned 156,932 samples with a learning rate 2e-4 for 6 epochs, conducted on 8× 80G A100 GPUS for 36 hours. Specifically, the layered digital design system 102 scales the design sample (e.g., reference) with the longer side set to 336 pixels and the removal models operate at a resolution of 512×512 which is the size of the final output.

In addition to the above details, in one or more embodiments, experiments conducted ablation studies of the layered digital design system 102. Specifically, experimenters conducted ablation studies to determine 1) whether the multi-modal language model should be trained separately or jointly across multiple tasks, 2) whether OCR data included as part of the prompt enhances the multi-modal language model, 3) whether the removal task benefits from having the multi-modal language model select a result from a set of results (e.g., the questionnaire dataset).

Regarding the first inquiry, experimenters determined that joint training and separate training yield comparable average scores, however joint training outperforms separate training by a margin of 0.82%. Regarding the second inquiry, experimenters determined that for text recognition tasks for parsing an original design, there were improvements in paragraph level OCR normalized edit distance by 7.23%. Further, for the text detection task in both the original and generative AI designs, the average detection F1 score is improved by 5.46%, thus the OCR data as part of the prompt enhances the performance of the multi-modal language model. Regarding the third inquiry, experimenters determined that for the text removal task, the PSNR increases from 31.31 to 31.97 and for object removal tasks, the PSNR improves from 29.33 to 29.59.

The following is an ablation studies table about the experiment on the benefits of joint training.

| | Separate | Joint |
|---|---|---|
| Metrics | Training | Training |
| Original Design | | |
| Text detection F1 | 75.42 | 78.59 |
| Text Recognition NED | 72.87 | 68.51 |
| Object Detection F1 | 82.17 | 84.64 |
| Color Accuracy | 26.66 | 28.09 |
| Font Accuracy | 24.51 | 21.62 |
| Line Number Accuracy | 86.96 | 86.28 |
| Alignment Accuracy | 87.28 | 88.60 |
| Angle Accuracy | 90.16 | 91.52 |
| Designs with | | |
| Nonsensical Text | | |
| Object Detection F1 | 79.27 | 83.06 |
| Backgrounds without Text | | |
| Object Detection F1 | 83.52 | 86.94 |
| Questionnaire | | |
| Result Selection | | |
| Selection Accuracy | 83.54 | 83.54 |
| Average Score | 72.03 | 72.85 |

In one or more embodiments, the layered digital design system 102 treats paragraph-level text as a single entity. In contrast, existing systems predict a style for each word individually, which leads to a visually disorganized appearance. Moreover, in some embodiments, the layered digital design system 102 groups words together at a paragraph level which more effectively considers the coherence of sentence semantics during translation. In other words, the layered digital design system 102 ensures consistent style and alignment of adjacent words. On the other hand, existing systems operate at a word level and lack overall contextual info in translation, which leads to disorganized layouts with overlapping text.

As mentioned above, existing systems that leverage generative models to produce text images typically produce nonsensical text. In one or more embodiments, the layered digital design system 102 effectively refines nonsensical text images by not continuing to follow an original text reference (e.g., after an initial text removal stage), rather the layered digital design system 102 uses the background as the new reference and adds text on the background to explore new text layouts. Furthermore, the layered digital design system 102 applies editing only on the background layer and then recomposes all the layers so that the quality of the text area is preserved. Accordingly, the layered digital design system 102 demonstrates versatility, flexibility, which is critical for generating high-quality and accurate layered digital design documents from pixel-based images.

Turning to FIG. 8, additional detail will now be provided regarding various components and capabilities of the layered digital design system 102. In particular, FIG. 8 illustrates an example schematic diagram of a computing device 800 (e.g., the server(s) 104 and/or the client device 110) implementing the layered digital design system 102 in accordance with one or more embodiments of the present disclosure for components 800-808. As illustrated in FIG. 8, the layered digital design system 102 includes a multi-modal language model manager 801 and associated multi-modal language model 803, a design plan architecture manager 802, a layered digital design manager 804, a graphical user interface manager 806, and a storage manager 808.

The multi-modal language model manager 801 interacts with the aforementioned components and oversees training, the generation of tokens (e.g., image and text tokens) to create various outputs. For example, the multi-modal language model manager 801 utilizes a multi-modal language model 803 to process text input (e.g., a user intention, a digital sketch, a prompt), and in some embodiments generates the reference image. Specifically, the multi-modal language model manager 801 generates a design plan architecture from a reference image by using a multi-modal language model 803.

The design plan architecture manager 802 generates a design plan architecture. For example, the accesses a reference image and extracts design elements from the reference image to create the design plan architecture. In one or more embodiments, the design plan architecture manager 802 assists the multi-modal language model manager 801 in training a multi-modal language model 803 to accurately create a design plan architecture. Specifically, the design plan architecture manager 802 access template data from existing digital design templates to optimize a multi-modal language model to generate JSON outputs that define a reference image in a bottom-top order.

The layered digital design manager 804 generates a layered digital design document from a reference image. For example, the layered digital design manager 804 extracts design elements from a reference image according to the design plan architecture and further constructs the layered digital design document from the extracted design elements. In other words, the layered digital design manager 804 intelligently creates layers (e.g., background layer, text layer, object layers) by extracting design elements according to the design plan architecture.

The graphical user interface manager 806 provides a generated layered digital design document to a graphical user interface of a client device. For example, the graphical user interface manager 806 manages interface elements of a client device such as providing input to provide a rasterized image, input to provide requirements to generate a reference image, and inputs to further modify a layered digital design document.

The storage manager 808 stores various components generated by the layered digital design system 102. For example, the storage manager 808 stores model parameters for a multi-modal language model, user intentions, digital sketches, prompts, reference images, design plan architectures, layered digital design documents, and training data. Specifically, the storage manager 808 further stores inference-time data for future iterations of training a multi-modal language model.

Each of the components 800-808 of the layered digital design system 102 can include software, hardware, or both. For example, the components 800-808 can include one or more instructions stored on a computer-readable storage medium and executable by processors of one or more computing devices, such as a client device or server device. When executed by the one or more processors, the computer-executable instructions of the layered digital design system 102 can cause the computing device(s) to perform the methods described herein. Alternatively, the components 800-808 can include hardware, such as a special-purpose processing device to perform a certain function or group of functions. Alternatively, the components 800-808 of the layered digital design system 102 can include a combination of computer-executable instructions and hardware.

Furthermore, the components 800-808 of the layered digital design system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 800-808 of the layered digital design system 102 may be implemented as a stand-alone application, such as a desktop or mobile application. Furthermore, the components 800-808 of the layered digital design system 102 may be implemented as one or more web-based applications hosted on a remote server. Alternatively, or additionally, the components 800-808 of the layered digital design system 102 may be implemented in a suite of mobile device applications or “apps.” For example, in one or more embodiments, the layered digital design system 102 can comprise or operate in connection with digital software applications such as ADOBE® ILLUSTRATOR®, ADOBE® PHOTOSHOP®, ADOBE® FIREFLY®, and/or ADOBE® EXPRESS®.

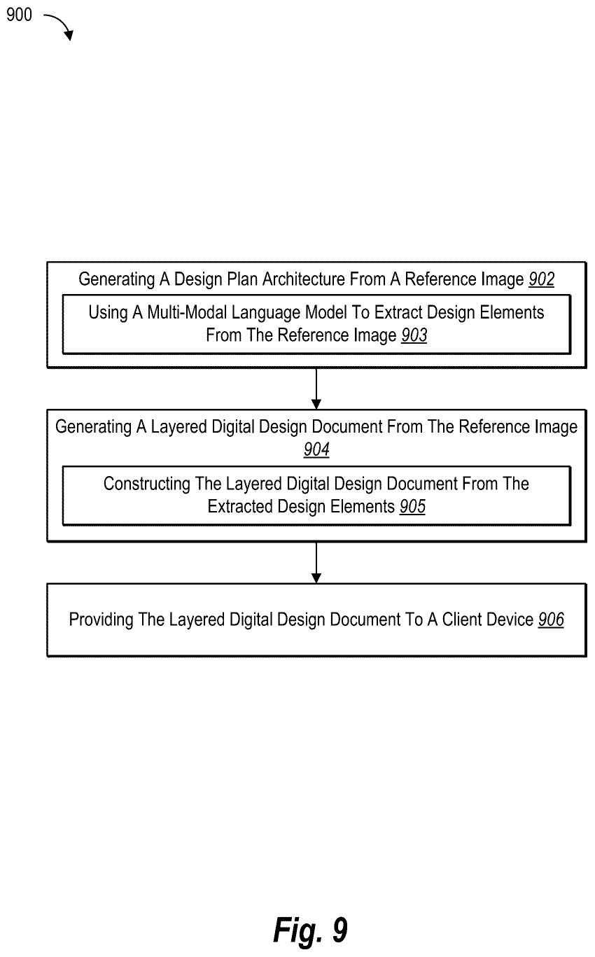

FIGS. 1-8, the corresponding text, and the examples provide a number of different methods, systems, devices, and non-transitory computer-readable media of the 800-808. In addition to the foregoing, one or more embodiments can also be described in terms of flowcharts comprising acts for accomplishing the particular result, as shown in FIG. 9. FIG. 9 may be performed with more or fewer acts. Further, the acts may be performed in different orders. Additionally, the acts described herein may be repeated or performed in parallel with one another or in parallel with different instances of the same or similar acts.

FIG. 9 illustrates a flowchart of a series of acts 900 for generating a layered digital design document in accordance with one or more embodiments. FIG. 9 illustrates acts according to one embodiment, alternative embodiments may omit, add to, reorder, and/or modify any of the acts shown in FIG. 9. In some implementations, the acts of FIG. 9 are performed as part of a method. For example, in one or more embodiments, the acts of FIG. 9 are performed as part of a computer-implemented method. Alternatively, a non-transitory computer-readable medium can store instructions thereon that, when executed by at least one processor, cause a computing device to perform the acts of FIG. 9. In one or more embodiments, a system performs the acts of FIG. 9. For example, in one or more embodiments, a system includes at least one memory device. The system further includes at least one server device configured to cause the system to perform the acts of FIG. 9.

The series of acts 900 includes an act 902 of generating a design plan architecture form a reference image. Moreover, the act 902 includes a sub-act 903 of using a multi-modal language model to extract design elements form the reference image. Further, the series of acts 900 includes an act 904 of generating a layered digital design document from the reference image. Moreover, the act 904 includes a sub-act 905 of constructing the layered digital design document from the extracted design elements. Moreover, the series of acts 900 includes an act 906 of providing the layered digital design document to a client device.

In particular, the act 902 includes generating, from a reference image comprising a digital design, a design plan architecture by extracting design elements from the reference image. Further, the act 904 includes generating a layered digital design document from the reference image by extracting the design elements from the reference image according to the design plan architecture and constructing the layered digital design document from the extracted design elements. Moreover, the act 906 includes providing, to a graphical user interface of a client device, the layered digital design document.

For example, in one or more embodiments, the series of acts 900 includes receiving a user intention to generate the digital design from the client device, wherein the user intention comprises at least one of digital text or a digital sketch from the client device. In addition, in one or more embodiments, the series of acts 900 includes generating, utilizing a multi-modal language model, a prompt from the user intention. Further, in one or more embodiments, the series of acts 900 includes generating, utilizing a text-to-image model, the reference image from the prompt, wherein the reference image is a rasterized digital image.

Further, in one or more embodiments, the series of acts 900 includes generating a prompt comprising a description of a task to generate the digital design. Moreover, in one or more embodiments, the series of acts 900 includes generating, utilizing a multi-modal language model to process the prompt and the reference image, the design plan architecture, wherein the design plan architecture comprises a plurality of steps that indicate attributes of the design elements arranged in a bottom-top order in the reference image.

Further, in one or more embodiments, the series of acts 900 includes generating, utilizing an encoder of the multi-modal language model, text tokens for the prompt. Moreover, in one or more embodiments, the series of acts 900 includes generating, utilizing an image encoder of the multi-modal language model, image tokens for the reference image. Further, in one or more embodiments, the series of acts 900 includes generating spatial encodings for the image tokens of the reference image and for the prompt.

Moreover, in one or more embodiments, the series of acts 900 includes identifying one or more text object elements in the reference image according to the design plan architecture. Additionally, in one or more embodiments, the series of acts 900 includes removing, utilizing a multi-modal language model, the one or more text object elements in the reference image. Moreover, in one or more embodiments, series of acts 900 includes based on removing the one or more text object elements in the reference image, generating a plurality of layers without the one or more text object elements. Further, in one or more embodiments, the series of acts 900 includes selecting, utilizing the multi-modal language model, a layer without the one or more text object elements from the plurality of layers to utilize as part of the layered digital design document.

Furthermore, in one or more embodiments, the series of acts 900 includes identifying, utilizing a segmentation model, a first foreground object in the reference image according to the design plan architecture. Moreover, in one or more embodiments, the series of acts 900 includes removing, utilizing the multi-modal language model, the first foreground object from the reference image.

Moreover, in one or more embodiments, the series of acts 900 includes identifying, utilizing a segmentation model, a second foreground object in the reference image according to the design plan architecture. Further, in one or more embodiments, the series of acts 900 includes removing, utilizing the multi-modal language model, the second foreground object from the reference image. Moreover, in one or more embodiments, the series of acts 900 includes based on removing the second foreground object from the reference image, obtaining the reference image that includes a background image. Further, in one or more embodiments, the series of acts 900 includes constructing the layered digital design document comprising a text layer of the one or more text object elements, a first object layer of a first foreground object, a second object layer of the second foreground object, and a background layer of the background image.

Moreover, in one or more embodiments, the series of acts 900 includes generating, from a reference image comprising a digital design, a design plan architecture comprising a plurality of steps that indicate attributes of design elements arranged in a bottom-top order in the reference image. Further, in one or more embodiments, the series of acts 900 includes iteratively processing the reference image by extracting the design elements from the reference image according to the bottom-top order of the design plan architecture to generate a layered digital design document. Moreover, in one or more embodiments, the series of acts 900 includes providing, to a graphical user interface of a client device, the layered digital design document.

Further, in one or more embodiments, the series of acts 900 includes receiving a user intention to generate the digital design from the client device, wherein the user intention comprises digital text and a digital sketch from the client device. Moreover, in one or more embodiments, the series of acts 900 includes generating, utilizing a multi-modal language model, a prompt from the user intention. Further, in one or more embodiments, the series of acts 900 includes generating, utilizing a text-to-image model, the reference image from the prompt, wherein the reference image is a pixel image.

Moreover, in one or more embodiments, the series of acts 900 includes generating a combined prompt by combining a task description, a description from the prompt, and optical character recognition data from the reference image. Further, in one or more embodiments, the series of acts 900 includes generating, utilizing the multi-modal language model, the design plan architecture from the combined prompt and the reference image. Moreover, in one or more embodiments, the series of acts 900 includes generating the plurality of steps of the design plan architecture that indicates an order of layers in the reference image and further indicates attributes of design elements that comprises content, bounding boxes, color elements, and font elements.

Further, in one or more embodiments, the series of acts 900 includes identifying text object elements in the reference image according to the design plan architecture. Moreover, in one or more embodiments, the series of acts 900 includes removing, utilizing a multi-modal language model, the text object elements in the reference image. Moreover, in one or more embodiments, the series of acts 900 includes identifying, utilizing a segmentation model, a first foreground object in the reference image according to the design plan architecture. Further, in one or more embodiments, the series of acts 900 includes removing, utilizing the multi-modal language model, the first foreground object from the reference image.

Moreover, in one or more embodiments, the series of acts 900 includes constructing the layered digital design document comprising a text layer of the text object elements, a first object layer of a first foreground object, and a background layer of a background image.

Further, in one or more embodiments, the series of acts 900 includes generating, utilizing a multi-modal language model to process a reference image, a design plan architecture by extracting design elements from the reference image. Moreover, in one or more embodiments, the series of acts 900 includes sequentially removing the design elements from the reference image according to the design plan architecture. Further, in one or more embodiments, the series of acts 900 includes generating a layered digital design document from the sequentially removed design elements. Moreover, in one or more embodiments, the series of acts 900 includes providing, to a graphical user interface of a client device, the layered digital design document.

Further, in one or more embodiments, the series of acts 900 includes receiving a user intention to generate a digital design from the client device, wherein the user intention comprises digital text from the client device. Moreover, in one or more embodiments, the series of acts 900 includes generating, utilizing the multi-modal language model, a prompt from the user intention. Further, in one or more embodiments, the series of acts 900 includes generating, utilizing a text-to-image model, the reference image from the prompt.

Moreover, in one or more embodiments, the series of acts 900 includes performing optical character recognition on the reference image to extract optical character recognition data. Further, in one or more embodiments, the series of acts 900 includes generating a combined prompt by combining a prompt of a user intention from the client device with the optical character recognition data. Moreover, in one or more embodiments, the series of acts 900 includes generating the design plan architecture by processing the combined prompt and the reference image utilizing the multi-modal language model.

Further, in one or more embodiments, the series of acts 900 includes removing, utilizing the multi-modal language model, one or more text object elements referenced by the design plan architecture in the reference image. In one or more embodiments, the series of acts 900 includes removing, utilizing the multi-modal language model, a first foreground object referenced by the design plan architecture from the reference image. In one or more embodiments, the series of acts 900 includes removing, utilizing the multi-modal language model, a second foreground object referenced by the design plan architecture from the reference image. In one or more embodiments, the series of acts 900 includes constructing the layered digital design document comprising a text layer of the one or more text object elements, a first object layer of the first foreground object, a second object layer of the second foreground object, and a background layer of a background image.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In one or more embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates a block diagram of an example computing device 1000 that may be configured to perform one or more of the processes described above. One will appreciate that one or more computing devices, such as the computing device 1000 may represent the computing devices described above (e.g., the server(s) 104 and/or the client device 110). In one or more embodiments, the computing device 1000 may be a mobile device (e.g., a mobile telephone, a smartphone, a PDA, a tablet, a laptop, a camera, a tracker, a watch, a wearable device). In one or more embodiments, the computing device 1000 may be a non-mobile device (e.g., a desktop computer or another type of client device). Further, the computing device 1000 may be a server device that includes cloud-based processing and storage capabilities.

As shown in FIG. 10, the computing device 1000 can include one or more processor(s) 1002, memory 1004, a storage device 1006, input/output interfaces 1008 (or “I/O interfaces 1008”), and a communication interface 1010, which may be communicatively coupled by way of a communication infrastructure (e.g., bus 1012). While the computing device 1000 is shown in FIG. 10, the components illustrated in FIG. 10 are not intended to be limiting. Additional or alternative components may be used in other embodiments. Furthermore, in certain embodiments, the computing device 1000 includes fewer components than those shown in FIG. 10. Components of the computing device 1000 shown in FIG. 10 will now be described in additional detail.

In particular embodiments, the processor(s) 1002 include hardware for executing instructions, such as those making up a computer program. As an example, and not by way of limitation, to execute instructions, the processor(s) 1002 may retrieve (or fetch) the instructions from an internal register, an internal cache, memory 1004, or a storage device 1006 and decode and execute them.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1004 may be internal or distributed memory.

The computing device 1000 includes a storage device 1006 including storage for storing data or instructions. As an example, and not by way of limitation, the storage device 1006 can include a non-transitory storage medium described above. The storage device 1006 may include a hard disk drive (HDD), flash memory, a Universal Serial Bus (USB) drive or a combination these or other storage devices.

As shown, the computing device 1000 includes one or more I/O interfaces 1008, which are provided to allow a user to provide input to (such as user strokes), receive output from, and otherwise transfer data to and from the computing device 1000. These I/O interfaces 1008 may include a mouse, keypad or a keyboard, a touch screen, camera, optical scanner, network interface, modem, other known I/O devices or a combination of such I/O interfaces 1008. The touch screen may be activated with a stylus or a finger.

The I/O interfaces 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1008 are configured to provide graphical data to a display for presentation to a user. The graphical data may be representative of one or more graphical user interfaces and/or any other graphical content as may serve a particular implementation.

The computing device 1000 can further include a communication interface 1010. The communication interface 1010 can include hardware, software, or both. The communication interface 1010 provides one or more interfaces for communication (such as, for example, packet-based communication) between the computing device and one or more other computing devices or one or more networks. As an example, and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can include hardware, software, or both that connects components of computing device 1000 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed:

1. A computer-implemented method comprising:
generating, from a reference image comprising a digital design, a design plan architecture by extracting design elements from the reference image;
generating a layered digital design document from the reference image by extracting the design elements from the reference image according to the design plan architecture and constructing the layered digital design document from the extracted design elements; and
providing, to a graphical user interface of a client device, the layered digital design document.

2. The computer-implemented method of claim 1, further comprising generating the reference image by:
receiving a user intention to generate the digital design from the client device, wherein the user intention comprises at least one of digital text or a digital sketch from the client device;
generating, utilizing a multi-modal language model, a prompt from the user intention; and
generating, utilizing a text-to-image model, the reference image from the prompt, wherein the reference image is a rasterized digital image.

3. The computer-implemented method of claim 1, wherein generating the design plan architecture further comprises:
generating a prompt comprising a description of a task to generate the digital design; and
generating, utilizing a multi-modal language model to process the prompt and the reference image, the design plan architecture,
wherein the design plan architecture comprises a plurality of steps that indicate attributes of the design elements arranged in a bottom-top order in the reference image.

4. The computer-implemented method of claim 3, wherein generating the design plan architecture further comprises:
generating, utilizing an encoder of the multi-modal language model, text tokens for the prompt;
generating, utilizing an image encoder of the multi-modal language model, image tokens for the reference image; and
generating spatial encodings for the image tokens of the reference image and for the prompt.

5. The computer-implemented method of claim 1, wherein generating the layered digital design document further comprises:
identifying one or more text object elements in the reference image according to the design plan architecture; and
removing, utilizing a multi-modal language model, the one or more text object elements in the reference image.

6. The computer-implemented method of claim 5, further comprising:
based on removing the one or more text object elements in the reference image, generating a plurality of layers without the one or more text object elements; and
selecting, utilizing the multi-modal language model, a layer without the one or more text object elements from the plurality of layers to utilize as part of the layered digital design document.

7. The computer-implemented method of claim 5, further comprising:
identifying, utilizing a segmentation model, a first foreground object in the reference image according to the design plan architecture; and
removing, utilizing the multi-modal language model, the first foreground object from the reference image.

8. The computer-implemented method of claim 5, further comprising:
identifying, utilizing a segmentation model, a second foreground object in the reference image according to the design plan architecture; and
removing, utilizing the multi-modal language model, the second foreground object from the reference image.

9. The computer-implemented method of claim 8, further comprising:
based on removing the second foreground object from the reference image, obtaining the reference image that includes a background image; and
constructing the layered digital design document comprising a text layer of the one or more text object elements, a first object layer of a first foreground object, a second object layer of the second foreground object, and a background layer of the background image.

10. A system comprising:
one or more memory devices; and
one or more processors configured to cause the system to:
generate, from a reference image comprising a digital design, a design plan architecture comprising a plurality of steps that indicate attributes of design elements arranged in a bottom-top order in the reference image;
iteratively process the reference image by extracting the design elements from the reference image according to the bottom-top order of the design plan architecture to generate a layered digital design document; and
provide, to a graphical user interface of a client device, the layered digital design document.

11. The system of claim 10, wherein the one or more processors are configured to cause the system to generate the reference image by:
receiving a user intention to generate the digital design from the client device, wherein the user intention comprises digital text and a digital sketch from the client device;
generating, utilizing a multi-modal language model, a prompt from the user intention; and
generating, utilizing a text-to-image model, the reference image from the prompt, wherein the reference image is a pixel image.

12. The system of claim 11, wherein the one or more processors are configured to cause the system to:
generate a combined prompt by combining a task description, a description from the prompt, and optical character recognition data from the reference image; and
generate, utilizing the multi-modal language model, the design plan architecture from the combined prompt and the reference image.

13. The system of claim 11, wherein the one or more processors are configured to cause the system to generate the plurality of steps of the design plan architecture that indicates an order of layers in the reference image and further indicates attributes of design elements that comprises content, bounding boxes, color elements, and font elements.

14. The system of claim 10, wherein the one or more processors are configured to cause the system to iteratively process the reference image by:
identifying text object elements in the reference image according to the design plan architecture;
removing, utilizing a multi-modal language model, the text object elements in the reference image;
identifying, utilizing a segmentation model, a first foreground object in the reference image according to the design plan architecture; and
removing, utilizing the multi-modal language model, the first foreground object from the reference image.

15. The system of claim 14, wherein the one or more processors are configured to cause the system to construct the layered digital design document comprising a text layer of the text object elements, a first object layer of a first foreground object, and a background layer of a background image.

16. A non-transitory computer-readable medium storing executable instructions which, when executed by at least one processing device, cause the at least one processing device to perform operations comprising:
generating, utilizing a multi-modal language model to process a reference image, a design plan architecture by extracting design elements from the reference image;
sequentially removing the design elements from the reference image according to the design plan architecture;
generating a layered digital design document from the sequentially removed design elements; and
providing, to a graphical user interface of a client device, the layered digital design document.

17. The non-transitory computer-readable medium of claim 16, further comprising generating the reference image by:
receiving a user intention to generate a digital design from the client device, wherein the user intention comprises digital text from the client device;
generating, utilizing the multi-modal language model, a prompt from the user intention; and
generating, utilizing a text-to-image model, the reference image from the prompt.

18. The non-transitory computer-readable medium of claim 16, wherein generating the design plan architecture comprises:
performing optical character recognition on the reference image to extract optical character recognition data;
generating a combined prompt by combining a prompt of a user intention from the client device with the optical character recognition data; and
generating the design plan architecture by processing the combined prompt and the reference image utilizing the multi-modal language model.

19. The non-transitory computer-readable medium of claim 16, wherein sequentially removing the design elements from the reference image according to the design plan architecture comprises:
removing, utilizing the multi-modal language model, one or more text object elements referenced by the design plan architecture in the reference image;
removing, utilizing the multi-modal language model, a first foreground object referenced by the design plan architecture from the reference image; and
removing, utilizing the multi-modal language model, a second foreground object referenced by the design plan architecture from the reference image.

20. The non-transitory computer-readable medium of claim 19, wherein the operations further comprise constructing the layered digital design document comprising a text layer of the one or more text object elements, a first object layer of the first foreground object, a second object layer of the second foreground object, and a background layer of a background image.
